(19) United States
(12) Patent Application Publication
(10) Pub. No.: US 2021/0359354 A1
(43) Pub. Date: Nov. 18, 2021

(54) THERMALLY CONDUCTIVE INSULATING SHEET AND METHOD FOR PREPARING SAME

(71) Applicant: Illinois Tool Works Inc., Glenview, IL (US)

(72) Inventors: Chunhua Yang, Shanghai (CN); Hongchuan Liao, Shanghai (CN)

(21) Appl. No.: 17/282,137

(22) PCT Filed: Sep. 30, 2019
(86) PCT No.: PCT/US2019/053850

§ 371 Date: Apr. 1, 2021

(30) Foreign Application Priority Data
Oct. 15, 2018 (CN) 201811196445.6

(51) Int. Cl. H01M 10/653; C09K 5/14; C08L 23/14; C08J 5/18; H01M 10/613; H01M 10/6554; H01B 3/44; B29C 48/08; B29C 48/00; B29C 48/92

(52) U.S. Cl. CPC H01M 10/653; B29K 2101/12; C08L 23/14; C08J 5/18; H01M 10/613; H01M 10/6554; H01B 3/441; B29C 48/08; B29C 48/0011; B29C 48/92; C08L 2201/02; C08L 2205/025; C08J 2323/14; C08J 2423/12; B29C 2948/92857; C09K 5/14

(57) ABSTRACT

The present application uses a thermoplastic resin as a substrate with the addition of a thermally conductive filler, a fire retardant and a toughener to jointly prepare a thermally conductive insulating sheet; the thermally conductive insulating sheet so prepared has thermally conductive, insulating, fire retardant and other properties, while a thickness of 0.05-1 mm can be attained. Furthermore, the present application uses a process of extrusion and rolling to prepare a thermally conductive insulating sheet with a thermoplastic resin as a substrate; the thickness can be precisely controlled, while it is possible to have no hole formation while ensuring a thin-wall state of the thermally conductive insulating sheet.

### RELATED APPLICATIONS

This international application claims priority to Chinese Patent Application Serial No. 201811196445.6, filed Oct. 15, 2018, entitled “A Heat Conductive Insulating Sheet and a Method for Preparing the Heat Conductive Insulating Sheet.” The entirety of Chinese Patent Application Serial No. 201811196445.6 is incorporated herein by reference.

### TECHNICAL FIELD

The present application relates to a thermally conductive insulating sheet and a method for producing same.

### BACKGROUND

Thermally conductive insulating sheet is used for isolating various electronic devices or components, in order to avoid failure due to short circuits or breakdown etc. between electronic devices (or components), or in electronic elements in electronic devices (or components), and reduce the risk of fire in electronic devices (or components), thereby ensuring normal operation of various electronic elements. For different uses of thermally conductive insulating sheet, it is required that the thermally conductive insulating sheet have different operating characteristics. For example, when used in certain electronic devices (or components), it is required that the thermally conductive insulating sheet have excellent thermal conductivity, wear resistance and strength etc.

Thus, it is hoped to provide a thermally conductive insulating sheet with excellent properties.

### SUMMARY

One object of the present application is to provide an improved thermally conductive insulating sheet, which not only has excellent thermally conductive, insulating and fire retarding properties, but at the same time has good fitting properties, excellent wear resistance, high strength and excellent toughness.

In order to attain the above object, a first aspect of the present application consists of providing a thermally conductive insulating sheet comprising: a thermoplastic resin, a thermally conductive filler and a fire retardant, wherein the thermally conductive insulating sheet has a single-layer structure.

In the thermally conductive insulating sheet as described above, the thermoplastic resin is selected from one or more of homopolymerized PP, PC, PET and PA.

In the thermally conductive insulating sheet as described above, the thermoplastic resin is copolymerized PP.

In the thermally conductive insulating sheet as described above, the thermoplastic resin further comprises copolymerized PP.

The thermally conductive insulating sheet as described above further comprises a toughener selected from one or more of addition-type rubber and organosilicon containing an —OH end group.

The thermally conductive insulating sheet as described above is produced by processing and forming using a process of extrusion and rolling.

The thickness of the thermally conductive insulating sheet as described above is 0.05-1 mm.

In the thermally conductive insulating sheet as described above, the weight of the thermally conductive filler accounts for 50-75% of the thermally conductive insulating sheet, and the thermally conductive filler is selected from one or more of magnesium oxide, alumina, boron nitride, silicon nitride and anodized aluminum powder.

In the thermally conductive insulating sheet as described above, the fire retardant is selected from one or more of bromine and chlorine halogenated fire retardants and phosphorus, nitrogen, sulfonate salt and silicon type halogen-free fire retardants.

The thermally conductive insulating sheet as described above has a thermal conductivity coefficient higher than 1.0 W/m*K, a breakdown voltage higher than 1 kV, a surface resistance higher than 109Ω, a flammability rating of VTM-0 or V-0, and a relative temperature index higher than 100° C.

The thermally conductive insulating sheet as described above is used in a battery pack, wherein the battery pack comprises multiple batteries and a heat dissipating medium, and at least one layer of the thermally conductive insulating sheet is disposed between the multiple batteries and the heat dissipating medium.

A second aspect of the present application consists of providing a method for preparing a thermally conductive insulating sheet, the method comprising: extruding thermally conductive insulating particles on an extruder to form a sheet material in a molten state, the thermally conductive insulating particles comprising a thermoplastic resin, a thermally conductive filler and a fire retardant; and supplying the sheet material in the molten state to a rolling mill in order to roll and form the sheet material in the molten state into the thermally conductive insulating sheet.

The method according to the second aspect of the present application comprises adjusting a roller temperature, a roller gap and a roller pressure of the rolling mill in order to control the thickness of the thermally conductive insulating sheet.

The method according to the second aspect of the present application comprises controlling a roller rotation speed of the rolling mill and an extrusion speed at which the sheet material in the molten state is extruded from a die head of the extruder, such that the roller rotation speed is less than the extrusion speed, so that the sheet material in the molten state accumulates at an inlet of the roller.

A third aspect of the present application consists of providing a thermally conductive insulating sheet having a structure of two or more layers, wherein each layer in the thermally conductive insulating sheet comprises: a thermoplastic resin, a thermally conductive filler and a fire retardant.

In the thermally conductive insulating sheet according to the third aspect of the present application, the thermoplastic resin is selected from one or more of homopolymerized PP, PC, PET and PA.

In the thermally conductive insulating sheet according to the third aspect of the present application, the thermoplastic resin is copolymerized PP.

In the thermally conductive insulating sheet according to the third aspect of the present application, the thermoplastic resin further comprises copolymerized PP.

The thermally conductive insulating sheet according to the third aspect of the present application further comprises a toughener selected from one or more of addition-type rubber and organosilicon containing an —OH end group.

The thermally conductive insulating sheet according to the third aspect of the present application is produced by processing and forming using a process of extrusion and rolling.

The thickness of the thermally conductive insulating sheet according to the third aspect of the present application is 0.05-1 mm.

In the thermally conductive insulating sheet according to the third aspect of the present application, the weight of the thermally conductive filler accounts for 50-75% of the thermally conductive insulating sheet, and the thermally conductive filler is selected from one or more of magnesium oxide, alumina, boron nitride, silicon nitride and anodized aluminum powder.

The present application uses a thermoplastic resin as a substrate of the thermally conductive insulating sheet, and the thermally conductive insulating sheet so prepared has the characteristics of good fitting properties, excellent toughness, excellent wear resistance and high strength. In addition, the present application uses a processing and forming process of extrusion and rolling to prepare the thermally conductive insulating sheet, and when the thermally conductive insulating sheet so prepared has a thermal conductivity coefficient higher than 1.0 W/m*K, a breakdown voltage higher than 1 kV, a surface resistance higher than 109Ω, a flammability rating of VTM-0 or V-0 and a relative temperature index higher than 100° C., the thickness can attain a 0.05-1.00 mm thin-wall state.

### BRIEF DESCRIPTION OF THE DRAWINGS

FIG. 1 is a schematic diagram of a thermally conductive insulating sheet 100 in an embodiment of the present application.

FIG. 2 is a sectional view of the thermally conductive insulating sheet 100 in FIG. 1 along line A-A.

FIG. 3 is a schematic diagram of a thermally conductive insulating sheet 200 in another embodiment of the present application.

FIG. 4 is a sectional view of the thermally conductive insulating sheet 200 in FIG. 3 along line B-B.

FIG. 5 is a structural schematic diagram of a battery pack 501 containing the thermally conductive insulating sheet (100, 200).

FIG. 6 is a flow chart of a process for preparing the thermally conductive insulating sheet 100 in an embodiment of the present application.

FIG. 7 is a flow chart of a process for preparing the thermally conductive insulating sheet 200 in another embodiment of the present application.

### DETAILED DESCRIPTION

Various particular embodiments of the present application are described below with reference to the accompanying drawings, which form part of this Description. It should be understood that although terms indicating direction such as “front”, “rear”, “up”, “down”, “left” and “right” are used in the present application to describe various demonstrative structural parts and elements of the present application, these terms are used here merely in order to facilitate explanation, and are determined on the basis of demonstrative orientations shown in the drawings. Since the embodiments disclosed in the present application may be arranged according to different directions, these terms indicating direction serve merely as an explanation, and should not be regarded as a restriction. Where possible, identical or similar reference labels used in the present application denote identical components.

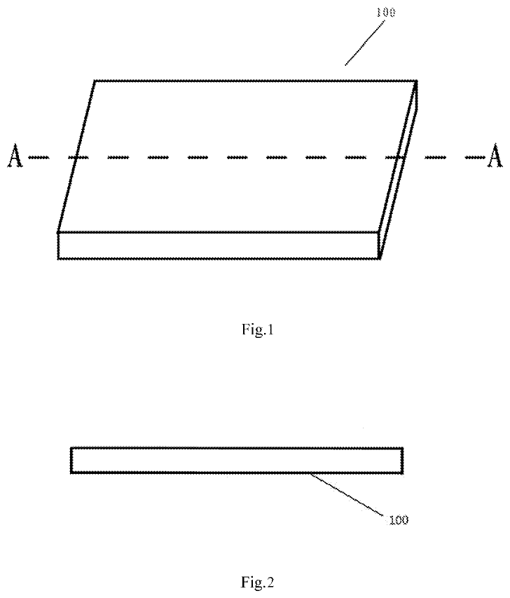

FIG. 1 shows a thermally conductive insulating sheet 100 in an embodiment of the present application. FIG. 2 is a sectional view of the thermally conductive insulating sheet 100 in FIG. 1 along line A-A. As shown in FIG. 2, the thermally conductive insulating sheet 100 is a single-layer structure.

The thermally conductive insulating sheet 100 is made using a thermoplastic resin as a substrate. The thermoplastic resin may be selected from at least one of polypropylene (PP), polycarbonate (PC), polyethylene terephthalate (PET) and polyamide (PA). The polypropylene used in the present application comprises copolymerized polypropylene (copolymerized PP) and homopolymerized polypropylene (PP). The thermoplastic resin used in the present application attains extrusion grade.

Thermally conductive insulating sheets commonly seen on the market are produced from silicone rubber and epoxy resin as substrates. The inventor of the present application has found that deficiencies are associated with thermally conductive insulating sheets made using silicone rubber and epoxy resin as substrates. A thermally conductive insulating sheet produced using silicone rubber as a substrate has poor wear resistance and is not voltage-resistant; a thermally conductive insulating sheet produced using epoxy resin as a substrate has poor toughness and cannot be cut easily. Thus, thermally conductive insulating sheets produced from silicone rubber or epoxy resin as a substrate are not suitable for use in service environments having requirements regarding sheet wear resistance, toughness and/or strength etc. (e.g. battery packs of electric vehicles, etc.). The thermally conductive insulating sheet 100 produced using a thermoplastic resin as a substrate in the present application overcomes the deficiencies of thermally conductive insulating sheets made using silicone rubber and epoxy resin as substrates, and not only has excellent insulating and thermally conductive properties, but also has excellent strength, toughness, wear resistance and voltage resistance, etc. and can be cut easily. Thus, the thermally conductive insulating sheet 100 of the present application is suitable for use in service environments having requirements regarding the wear resistance, toughness and strength etc. of the thermally conductive insulating sheet (e.g. battery packs of electric vehicles, etc.).

In one embodiment, the thermally conductive insulating sheet 100 comprises a thermally conductive filler, to increase the thermally conductive performance of the thermally conductive insulating sheet 100. In one embodiment, the weight percentage of the thermally conductive filler may account for 50-75% of the total weight of the thermally conductive insulating sheet 100. In another embodiment, the volume percentage of the thermally conductive filler may account for 35-45% of the total volume of the thermally conductive insulating sheet 100. The thermally conductive filler may be selected from one or more of magnesium oxide, alumina, boron nitride, silicon nitride and anodized aluminum powder. The anodized aluminum powder takes the form of a material having a surface wrapped by alumina in a sealed manner and an interior which is aluminum powder. Due to the fact that aluminum powder has electrical conductivity, aluminum powder is not suitable for use as the thermally conductive filler of the thermally conductive insulating sheet despite having excellent thermally conductive properties. The inventor of the present application has found that since the alumina formed on a surface layer of aluminum powder by anodization of the aluminum powder wraps the aluminum powder in a sealed manner within the alumina, the aluminum powder cannot conduct electricity, therefore anodized aluminum powder has both excellent thermally conductive properties and good insulating properties. In the present application, the use of anodized aluminum powder as the thermally conductive filler of the thermally conductive insulating sheet 100 results in the thermally conductive insulating sheet 100 of the present application having excellent thermally conductive properties and good electrically insulating properties.

The present application selects thermoplastic resins such as polypropylene (PP), polycarbonate (PC), polyethylene terephthalate (PET) and polyamide (PA) as substrates to prepare the thermally conductive insulating sheet 100, and makes use of the properties of the abovementioned thermoplastic resins in having good fluidity, excellent covering properties and a large free volume space, which facilitate the addition of the thermally conductive filler to the thermally conductive insulating sheet. According to the abovementioned embodiment of the present application, the amount of the thermally conductive filler added accounts for 50-75% of the total weight of the thermally conductive insulating sheet; even in the case where the proportion of thermally conductive filler in the thermally conductive insulating sheet is as high as this, the thermoplastic resin selected in the present application can still make use of the excellent fluidity and covering properties thereof to accomplish the smooth addition of the thermally conductive filler, in order to prepare the thermally conductive insulating sheet.

Conventionally, a thermoplastic resin material may be formed into a sheet by means of an extrusion process. However, the applicant has found that a conventional extrusion process is not suitable for forming a blend of a thermoplastic resin material and a thermally conductive filler into a thermally conductive insulating sheet. This is because the applicant has found that if the material used has poor toughness, since a conventional extrusion process relies on linear speed control to stretch a thick sheet into a thin sheet, the material is subjected to a stretching force from a forming roller during extrusion forming, therefore a large number of holes will form in the sheet that is produced, and these holes will cause the sheet to be easily broken down. In addition, the thermoplastic resin material has poor toughness, and after blending with the thermally conductive filler, the toughness of the blend of the thermoplastic resin material and the thermally conductive filler becomes even poorer. Thus, a sheet material obtained by forming a blend of a thermoplastic resin material and a thermally conductive filler using a conventional extrusion process might not have the desired insulating properties due to the presence of a large number of holes. Furthermore, it is hoped that the thermally conductive insulating sheet 100 of the present application has excellent thermally conductive properties, hence it is hoped that the thickness of the thermally conductive insulating sheet 100 of the present application is as small as possible, because the smaller the thickness of the sheet is, the better the thermally conductive properties of the sheet are. When an extrusion process is used to form a blend of a thermoplastic resin material and a thermally conductive filler into a sheet with a very small thickness, holes in the sheet have a more significant effect on the insulating properties of the sheet, such that the sheet that is produced cannot be used in an environment having requirements regarding the insulating properties thereof. Thus, the thermally conductive insulating sheet 100 of the present application is suited to being formed by a conventional extrusion process.

Advantageously, the thermally conductive insulating sheet 100 of the present application is made using a process of extrusion and rolling, such that the thermally conductive insulating sheet 100 of the present application has excellent insulating properties and thermally conductive properties. In the course of the process of extrusion and rolling that is provided in the present application, a blend of a thermoplastic resin material and a thermally conductive filler is extruded by an extruder die head and is then sent to a rolling mill to be rolled. Since rolling consists of rolling a thick sheet into a thin sheet, the blend of the thermoplastic resin material and the thermally conductive filler is not subjected to a stretching force in a roller of the rolling mill, hence holes in the thermally conductive insulating sheet 100 produced are reduced or avoided, ensuring that the thermally conductive insulating sheet 100 of the present application has excellent insulating properties. More advantageously, since the process of extrusion and rolling that is provided in the present application reduces or avoids holes in the thermally conductive insulating sheet 100 produced, the thermally conductive insulating sheet 100 of the present application may have a very thin thickness. In one embodiment, the thickness of the thermally conductive insulating sheet 100 is 0.05-1.00 mm. In another embodiment, the thickness of the thermally conductive insulating sheet 100 is 0.05-0.5 mm. Due to the very thin thickness of the thermally conductive insulating sheet 100 of the present application, the thermally conductive insulating sheet 100 has better thermally conductive properties. Thus, the thermally conductive insulating sheet 100 of the present application that is produced by the process of extrusion and rolling provided in the present application has excellent insulating properties and thermally conductive properties at the same time.

In one embodiment, the thermally conductive insulating sheet 100 comprises a toughener, to improve the toughness of the thermoplastic resin. Since the toughener increases the toughness of the thermoplastic resin substrate, the formation of holes in the thermally conductive insulating sheet 100 can be avoided or reduced in the processing and forming process of manufacturing the thermally conductive insulating sheet 100, so that the thermally conductive insulating sheet 100 has excellent electrical insulating properties. Moreover, since the toughener can avoid or reduce the formation of holes in the thermally conductive insulating sheet 100, the toughener is of assistance in giving the thermally conductive insulating sheet 100 a smaller thickness, so that the thermally conductive insulating sheet has excellent thermally conductive properties. The toughener may be selected from one or more of copolymerized polypropylene (PP), addition-type rubber and organosilicon containing an —OH end group. The inventor of the present application has found that when the thermally conductive insulating sheet 100 comprises the thermoplastic resin and thermally conductive filler, organosilicon containing an —OH end group effectively increases the toughness of the thermoplastic resin by forming an action force between the thermoplastic resin and the thermally conductive filler. In one embodiment, the toughener accounts for 50%-70% of the weight of a remaining part, other than the thermally conductive filler, in the thermally conductive insulating sheet 100.

In one embodiment, the thermally conductive insulating sheet 100 is produced from copolymerized PP as a substrate. Since copolymerized PP has good toughness, in the case where copolymerized PP is used as a substrate to make the thermally conductive insulating sheet 100, the thermally conductive insulating sheet 100 need not comprise a toughener. In another embodiment, in the case where copolymerized PP is used as a substrate to make the thermally conductive insulating sheet 100, the thermally conductive insulating sheet 100 may also comprise a toughener, which may be selected from one or more of addition-type rubber and organosilicon containing an —OH end group.

In one embodiment, the thermally conductive insulating sheet 100 comprises a fire retardant, in order to increase the fire retardant properties of the thermally conductive insulating sheet 100. The fire retardant may be selected from one or more of a halogen-free fire retardant and a halogenated fire retardant. The halogenated fire retardant may comprise a brominated fire retardant and a chlorinated fire retardant. The halogen-free fire retardant may comprise a phosphorus-containing fire retardant, a nitrogen-containing fire retardant, a sulfonate salt fire retardant and a silicon-containing fire retardant. The fire retardants used in the present application all meet the requirements of the RoHS standard.

The thermally conductive insulating sheet 100 of the present application has excellent fitting properties, toughness, wear resistance and strength. The thermally conductive insulating sheet 100 of the present application, when having a thickness of 0.05-1 mm, has a thermal conductivity coefficient higher than 1.0 W/m*K, a breakdown voltage higher than 1 kV and a surface resistance higher than 109Ω; moreover, the flammability rating is VTM-0 or V-0, and the relative temperature index is higher than 100° C.

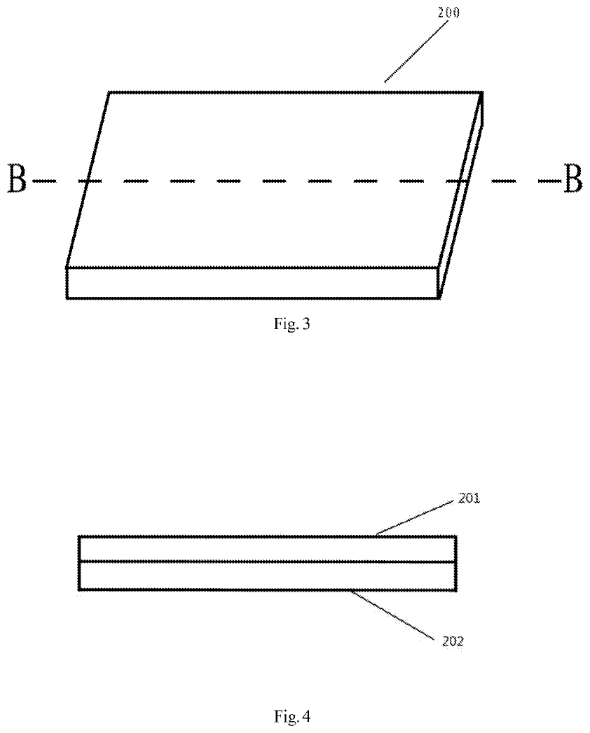

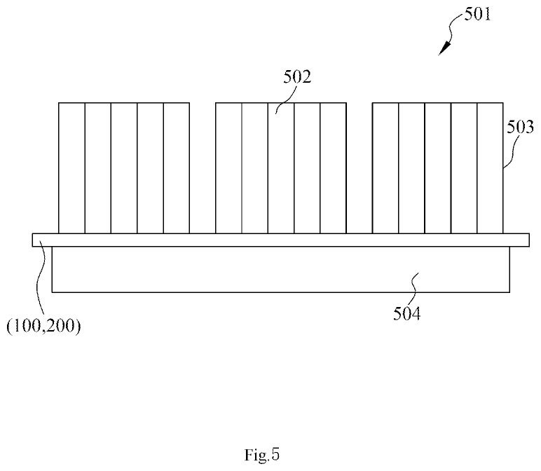

FIG. 3 shows a thermally conductive insulating sheet 200 in another embodiment of the present application. FIG. 4 is a sectional view of the thermally conductive insulating sheet 200 in FIG. 3 along line B-B. As shown in FIG. 4, the thermally conductive insulating sheet 200 is a two-layer structure. An upper layer 201 and a lower layer 202 of the thermally conductive insulating sheet 200 may be made from the same material or different materials.

Although the present application only shows thermally conductive insulating sheets having one-layer and two-layer structures, those skilled in the art can understand that the thermally conductive insulating sheet of the present application may be formed to have a structure of three or more layers.

The thermally conductive insulating sheets 100, 200 of the present application are suitable for use in various electronic and electrical devices requiring thermal conduction and insulation. In one embodiment, the thermally conductive insulating sheets 100, 200 of the present application are used in a battery pack of an electric vehicle. FIG. 5 is a structural schematic diagram of a battery pack 501 using the thermally conductive insulating sheet 100, 200. As shown in FIG. 5, the battery pack 501 comprises three batteries 503, with each battery 503 being formed of multiple cell units 502. In other embodiments, the battery pack 501 could also comprise another number of batteries 503, e.g. one, two or four, etc. The battery pack 501 also comprises a heat dissipating medium 504, for emitting heat generated by the cell units 502 during discharge. The thermally conductive insulating sheet 100, 200 is disposed between the bottom of the three batteries 503 and the heat dissipating medium 504. One side of the thermally conductive insulating sheet 100, 200 is in contact with a bottom surface of the batteries 503, while another side is in contact with an upper surface of the heat dissipating medium 504, in order to transfer heat from the cell units 502 to the heat dissipating medium 504, so as help the heat dissipating medium 504 to emit the heat from the cell units 502.

The thermally conductive insulating sheet in the battery pack of the electric vehicle is susceptible to forces such as friction and impact during movement of the electric vehicle, therefore it is required that the thermally conductive insulating sheet have properties such as good wear resistance, toughness and strength. As described above, the thermally conductive insulating sheet 100, 200 produced using the thermoplastic resin as a substrate in the present application not only has excellent insulating and thermally conductive properties, but at the same time also has excellent strength, toughness and wear resistance, and is therefore suitable for use in the battery pack of an electric vehicle.

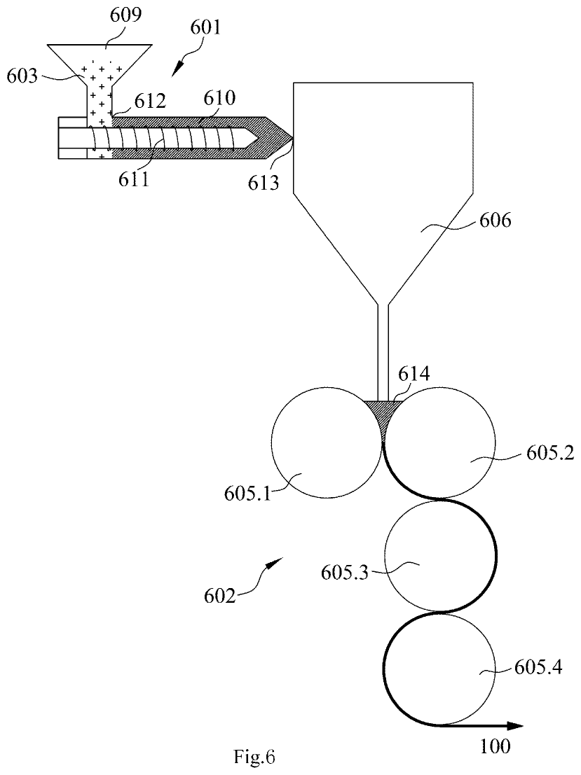

FIG. 6 shows a procedure of a process of extrusion and rolling for preparing the thermally conductive insulating sheet 100 in an embodiment of the present application. The process procedure as shown in FIG. 6 employs an extruder 601 and a rolling mill 602. The extruder 601 comprises a feed hopper 609, an accommodating cavity 610 and a die head 606. The feed hopper 609 is used for receiving plastic particles 603; the plastic particles 603 are formed of the same component(s) as the thermally conductive insulating sheet 100. The accommodating cavity 610 is provided with a drive screw 611; an outlet of the feed hopper 609 is in communication with a front end inlet 612 of the accommodating cavity 610; a rear end outlet 613 of the accommodating cavity 610 is in communication with an inlet of the die head 606. The interior of the die head 606 has a suitable width and depth, sufficient to accommodate material delivered from the accommodating cavity 610; the interior of the die head 606 is flat, such that material delivered from the accommodating cavity 610 is mold-pressed therein to form a thick sheet. The mold-pressed material is delivered to the rolling mill 602 from an outlet of the die head 606. The rolling mill 602 comprises multiple rollers; in FIG. 6, four rollers 605.1, 605.2, 605.3 and 605.4 are shown. Material delivered from the die head 606 to the rolling mill 602 is subjected to the action of pressure between the rollers, thereby attaining the desired thickness and being cooled and formed into the thermally conductive insulating sheet 100 by the rollers. In other embodiments, other numbers of rollers are also possible.

In accordance with the procedure of the process of extrusion and rolling shown in FIG. 6, the preparation process of the thermally conductive insulating sheet 100 of the present application is as follows:

During production, the accommodating cavity 610 of the extruder 601 is heated, and the drive screw 611 of the extruder 601 is caused to rotate. The plastic particles 603 are added to the feed hopper 609 of the extruder 601. The rotation of the drive screw 611 of the extruder 601 pushes the plastic particles 603 in the feed hopper 609 into the accommodating cavity 610. Since the accommodating cavity 610 is heated, and the plastic particles 603 generate heat due to friction after entering the accommodating cavity 610, melting to a molten state is achieved. Due to the effect of the propulsive force arising from the rotation of the drive screw 611, the plastic in the molten state is conveyed toward the rear end outlet 613 of the accommodating cavity 610. The propulsive force arising from the rotation of the drive screw 611 causes the plastic in the molten state to flow out of the accommodating cavity 610 from the rear end outlet 613 of the accommodating cavity 610, and then enter the die head 606 through the die head inlet in communication with the rear end outlet 613 of the accommodating cavity 610, so that the plastic in the molten state is mold-pressed in the interior of the die head 606 to form a molten thick sheet material. The mold-pressed molten thick sheet material is delivered to the rolling mill 602, and sequentially passes between a first roller 605.1 and a second roller 605.2, between the second roller 605.2 and a third roller 605.3 and between the third roller 605.3 and a fourth roller 605.4, in order to obtain the thermally conductive insulating sheet 100. During preparation, a roller rotation speed of the rolling mill 602 and an extrusion speed at which the thick sheet material in the molten state is extruded from the die head 606 of the extruder 601 are controlled, keeping the extrusion speed of the die head 606 greater than the roller rotation speed of the rolling mill 602, so that the mold-pressed molten thick sheet material forms accumulated material 614 at the position of a roller inlet of the rolling mill 602. Since a rolling speed of the rolling mill 602 is lower than the extrusion speed of the die head 606, the molten thick sheet material, when being rolled by the rollers, is only subjected to the action of pressure of the corresponding rollers, without being subjected to the action of a stretching force. Since it is not subjected to the action of a stretching force, the molten thick sheet material does not easily develop holes during rolling, thereby ensuring that the thermally conductive insulating sheet 100 so prepared has excellent insulating properties. Furthermore, the thickness of the thermally conductive insulating sheet 100 can be precisely controlled by adjusting the temperature of the various rollers, the roller gap and the roller pressure. In the embodiment shown in FIG. 6, the rolling mill 602 is arranged below the die head 606 of the extruder 601, such that after the plastic in the molten state has been mold-pressed in the die head 606, the molten thick sheet material is conveyed downward such that the material can more easily form the accumulated material 614 at the roller inlet of the rolling mill 602. In other embodiments, the rolling mill 602 and the die head 606 of the extruder 601 may be arranged at the same horizontal height.

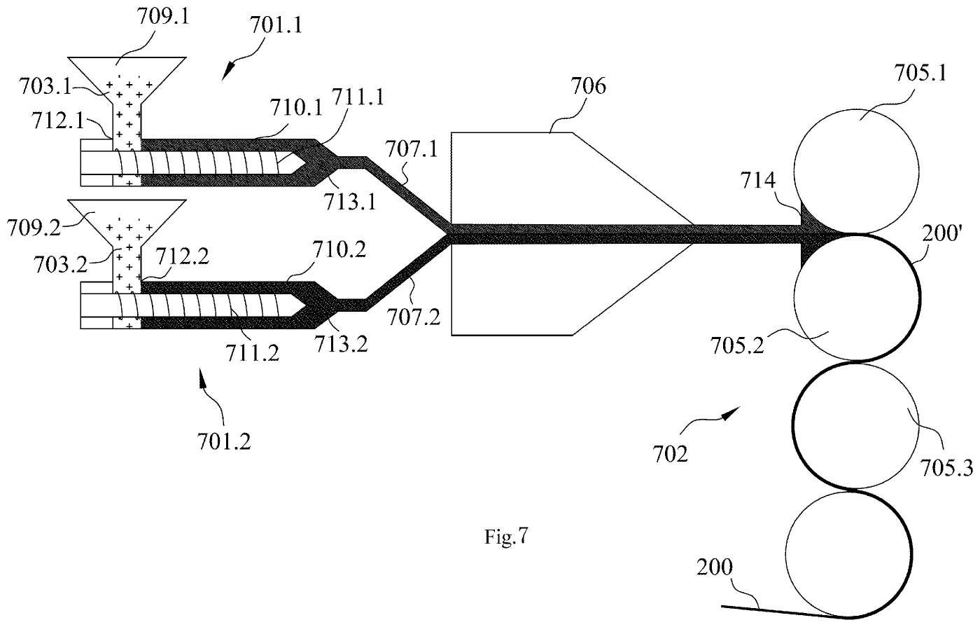

FIG. 7 shows a procedure of a process for preparing the thermally conductive insulating sheet 200 in another embodiment of the present application. As shown in FIG. 7, the process procedure for the thermally conductive insulating sheet 200 employs a first extruder 701.1, a second extruder 701.2 and a roller 702. Similarly to the extruder 601 shown in FIG. 6, the first extruder 701.1 comprises a first feed hopper 709.1, a first accommodating cavity 710.1 and a first drive screw 711.1; the second extruder 701.2 comprises a second feed hopper 709.2, a second accommodating cavity 710.2 and a second drive screw 711.2. The first feed hopper 709.1 is used for receiving first plastic particles 703.1; the component(s) of the first plastic particles 703.1 is/are the same as the component(s) of the upper layer of the thermally conductive insulating sheet 200, and the component(s) of the second plastic particles 703.2 is/are the same as the component(s) of the lower layer of the thermally conductive insulating sheet 200. An outlet of the feed hopper 709.1 is in communication with a front end inlet 712.1 of the accommodating cavity 710.1, and a rear end outlet 713.1 of the accommodating cavity 710.1 is in communication with an inlet of a die head 706 via a delivery pipeline 707.1; an outlet of the feed hopper 709.2 is in communication with a front end inlet 712.2 of the accommodating cavity 710.2, and a rear end outlet 713.2 of the accommodating cavity 710.2 is in communication with the inlet of the die head 706 via a delivery pipeline 707.2. In other words, the rear end outlets 713.1, 713.2 of the accommodating cavities of the first extruder 701.1 and the second extruder 701.2 are in communication with the die head 706 via the delivery pipelines 707.1 and 707.2 respectively; the interior of the die head 706 has a suitable width and depth, sufficient to accommodate material delivered from the accommodating cavities of the first extruder 701.1 and the second extruder 701.2; the interior of the die head 706 is flat, such that the delivered material is mold-pressed therein to form a two-layer thick sheet. The mold-pressed material is delivered to the rolling mill 702 from an outlet of the die head 706. The rolling mill 702 comprises multiple rollers; in FIG. 7, four rollers 705.1, 705.2, 705.3 and 705.4 are shown. Material delivered from the die head 706 to the rolling mill 702 is subjected to the action of pressure between the rollers, thereby attaining the desired thickness and being cooled and formed into the thermally conductive insulating sheet 200 by the rollers. In other embodiments, other numbers of rollers are also possible.

In accordance with the preparation process procedure shown in FIG. 7, the preparation process of the thermally conductive insulating sheet 200 of the present application is as follows:

During production, the first accommodating cavity 710.1 of the first extruder 701.1 is heated, and the first drive screw 711.1 of the first extruder 701.1 is caused to rotate. The first plastic particles 703.1 are added to the first feed hopper 709.1 of the first extruder 701.1. The rotation of the first drive screw 711.1 pushes the first plastic particles 703.1 in the first feed hopper 709.1 into the first accommodating cavity 710.1. Since the first accommodating cavity 710.1 is heated, and the first plastic particles 703.1 generate heat due to friction after entering the first accommodating cavity 710.1, melting to a molten state is achieved. Due to the effect of the propulsive force arising from the rotation of the first drive screw 711.1, the plastic in the molten state is conveyed toward the rear end outlet 713.1 of the first accommodating cavity 710.1. The propulsive force arising from the rotation of the first drive screw 711.1 causes the plastic in the molten state to flow out from the rear end outlet 713.1 of the first accommodating cavity 710.1, and then enter the die head 706 through the delivery pipeline 707.1. Similarly, the second plastic particles 703.2 are also delivered to the die head 706 in a molten state under the action of the second extruder 701.2. The first plastic and second plastic in the molten state are stuck together in the die head 706 to form an upper layer and a lower layer; the two-layer molten plastic is mold-pressed in the interior of the die head 706 to form a two-layer molten thick sheet material. The mold-pressed two-layer molten thick sheet material is delivered to the rolling mill 702, and sequentially passes between a first roller 705.1 and a second roller 705.2, between the second roller 705.2 and a third roller 705.3 and between the third roller 705.3 and a fourth roller 705.4, sequentially receiving pressure applied thereto by the various rollers, and the thermally conductive insulating sheet 200 is obtained through the cooling and forming thereof by the rollers.

Exactly as in the preparation process of the thermally conductive insulating sheet 100, during preparation of the thermally conductive insulating sheet 200, a roller rotation speed of the rolling mill 702 and an extrusion speed at which the thick sheet material in the molten state is extruded from the die head 706 must be controlled, keeping the extrusion speed of the die head 706 greater than the roller rotation speed of the rolling mill 702, so that the mold-pressed molten thick sheet material forms accumulated material 714 at the position of a roller inlet of the rolling mill 702. Since the roller rotation speed of the rolling mill 702 is lower than the extrusion speed of the die head 706, the molten thick sheet material, when being rolled by the rollers, is only subjected to the action of pressure of the corresponding rollers, without being subjected to the action of a stretching force. Since there is no action of a stretching force, the molten thick sheet material does not easily develop holes during rolling, thereby ensuring that the thermally conductive insulating sheet 200 prepared has good insulating properties. Furthermore, the thickness of the thermally conductive insulating sheet 200 can be precisely controlled by adjusting the temperature of the various rollers, the roller gap and the roller pressure.

Table 1 shows three embodiments of the thermally conductive insulating sheet with the single-layer structure in the present application, as well as the results of tests of the properties thereof.

TABLE 1

| | Embodiment 1 | Embodiment 2 | Embodiment 3 |
|---|---|---|---|
| Homopolymerized | 13 | 9 | 9 |
| PP (wt %) | | | |
| Copolymerized PP | 19 | 13 | 12 |
| (wt %) | | | |
| Sb₂O₃ + | 8 | 8 | 8 |
| decabromodiphenyl | | | |
| ethane (wt %) | | | |
| dimethyl | / | / | 1 |
| organosilicon | | | |
| containing —OH | | | |
| end (wt %) | | | |
| magnesium oxide | 60 | 70 | 70 |
| (wt %) | | | |
| sheet thickness, mm | 0.43 | 0.25 | 0.12 |
| thermal conductivity | 1.05 | 1.66 | 1.69 |
| coefficient, W/m*K | | | |
| breakdown voltage, | 6.13 | 3.16 | 1.65 |
| KV | | | |
| flammability rating | V-0 | VTM-0 | VTM-0 |

As shown in table 1, the thermally conductive insulating sheet prepared using the processing and forming process of extrusion and rolling of the present application, when having a very small thickness, has a thermal conductivity coefficient higher than 1.0 W/m*K and a breakdown voltage higher than 1 kV; the surface resistance is higher than 10⁹Ω, the flammability rating is VTM-0 or V-0, and the relative temperature index is higher than 100° C.

1. A thermally conductive insulating sheet, wherein the thermally conductive insulating sheet comprises:
a thermoplastic resin;
a thermally conductive filler; and
a fire retardant,
wherein the thermally conductive insulating sheet has a single-layer structure.

2. The thermally conductive insulating sheet as claimed in claim 1, wherein the thermoplastic resin is selected from one or more of homopolymerized PP, PC, PET and PA.

3. The thermally conductive insulating sheet as claimed in claim 1, wherein the thermoplastic resin is copolymerized PP.

4. The thermally conductive insulating sheet as claimed in claim 2, wherein the thermoplastic resin further comprises copolymerized PP.

5. The thermally conductive insulating sheet as claimed in claim 1, wherein the thermally conductive insulating sheet further comprises a toughener selected from one or more of addition-type rubber and organosilicon containing an —OH end group.

6. The thermally conductive insulating sheet as claimed in claim 1, wherein the thermally conductive insulating sheet is produced by processing and forming using a process of extrusion and rolling.

7. The thermally conductive insulating sheet as claimed in claim 1, wherein the thickness of the thermally conductive insulating sheet is 0.05-1 mm.

8. The thermally conductive insulating sheet as claimed in claim 1, wherein the weight of the thermally conductive filler accounts for 50-75% of the thermally conductive insulating sheet, and the thermally conductive filler is selected from one or more of magnesium oxide, alumina, boron nitride, silicon nitride and anodized aluminum powder.

9. The thermally conductive insulating sheet as claimed in claim 1, wherein the fire retardant is selected from one or more of bromine and chlorine halogenated fire retardants and phosphorus, nitrogen, sulfonate salt and silicon type halogen-free fire retardants.

10. The thermally conductive insulating sheet as claimed in claim 1, wherein the thermally conductive insulating sheet has a thermal conductivity coefficient higher than 1.0 W/m*K, a breakdown voltage higher than 1 kV, a surface resistance higher than 109Ω, a flammability rating of VTM-0 or V-0, and a relative temperature index higher than 100° C.

11. The thermally conductive insulating sheet as claimed in claim 1, wherein the thermally conductive insulating sheet is used in a battery pack, wherein the battery pack comprises multiple batteries and a heat dissipating medium, and at least one layer of the thermally conductive insulating sheet is disposed between the multiple batteries and the heat dissipating medium.

12. A method for preparing a thermally conductive insulating sheet, wherein the method comprises:
extruding thermally conductive insulating particles on an extruder to form a sheet material in a molten state, the thermally conductive insulating particles comprising a thermoplastic resin, a thermally conductive filler and a fire retardant; and
supplying the sheet material in the molten state to a rolling mill in order to roll and form the sheet material in the molten state into the thermally conductive insulating sheet.

13. The method as claimed in claim 12, wherein the method comprises adjusting a roller temperature, a roller gap and a roller pressure of the rolling mill in order to control the thickness of the thermally conductive insulating sheet.

14. The method as claimed in claim 13, wherein the method comprises controlling a roller rotation speed of the rolling mill and an extrusion speed at which the sheet material in the molten state is extruded from a die head of the extruder, such that the roller rotation speed is less than the extrusion speed, so that the sheet material in the molten state accumulates at an inlet of the roller.

15. A thermally conductive insulating sheet, wherein the thermally conductive insulating sheet has a structure of two or more layers, wherein each layer in the thermally conductive insulating sheet comprises:
a thermoplastic resin;
a thermally conductive filler; and
a fire retardant.

16. The thermally conductive insulating sheet as claimed in claim 15, wherein the thermoplastic resin is selected from one or more of homopolymerized PP, PC, PET and PA.

17. The thermally conductive insulating sheet as claimed in claim 15, wherein the thermoplastic resin is copolymerized PP.

18. The thermally conductive insulating sheet as claimed in claim 16, wherein the thermoplastic resin further comprises copolymerized PP.

19. The thermally conductive insulating sheet as claimed in claim 17, wherein the thermally conductive insulating sheet further comprises a toughener selected from one or more of addition-type rubber and organosilicon containing an —OH end group.

20. The thermally conductive insulating sheet as claimed in claim 15, wherein the thermally conductive insulating sheet is produced by processing and forming using a process of extrusion and rolling.

21-22. (canceled)
